(19) United States
(12) Patent Application Publication
(10) Pub. No.: US 2023/0117983 A1
(43) Pub. Date: Apr. 20, 2023

(54) Water-Soluble Coloring Compositions Comprising Alcohol Alkoxylates with 40 to 160 Ethoxy Units Derived from Primary Alcohols Having a Chain Length Between 20 and 30 Carbon Atoms

(71) Applicant: Sasol (USA) Corporation, Houston, TX (US)

(72) Inventors: Jennifer Bickel, Westlake, LA (US); Ollie Normand, Westlake, LA (US)

(21) Appl. No.: 17/911,599

(22) PCT Filed: Apr. 1, 2021
(86) PCT No.: PCT/US2021/025307

§ 371 Date: Sep. 14, 2022

Related U.S. Application Data
(60) Provisional application No. 63/004,097, filed on Apr. 2, 2020.

(51) Int. Cl. C09D 13/00; C08L 101/02; C08L 101/14; B29C 45/00; B29C 48/00; B29C 48/06; B29C 48/80; B29C 48/82

(52) U.S. Cl. CPC C09D 13/00; C08L 101/02; C08L 101/14; B29C 45/0001; B29C 48/022; B29C 48/06; B29C 48/802; B29C 48/82; B29L 2031/725

(57) ABSTRACT

The invention relates to water-soluble marking compositions comprising alcohol alkoxylates having 40 to 160 ethoxy units and derived from a primary alcohol having a chain length between 20 and 30 carbon atoms.

### CROSS-REFERENCE TO RELATED APPLICATION

This application claims priority to U.S. Ser. No. 63/004,097 filed Apr. 2, 2020, the disclosure of which is incorporated herein by reference for all purposes.

### FIELD OF THE INVENTION

The invention relates to water-soluble coloring compositions comprising alcohol alkoxylates having 40 to 160 ethoxy units and derived from a primary alcohol having a chain length between 20 and 30 carbon atoms.

### BACKGROUND OF THE INVENTION

Water-soluble coloring compositions are used in water-soluble paints, poster paints, for color brushes and for roller balls, crayons and the like. Such compositions comprise pigments, dyes and/or other coloring substances, which can be applied to different surfaces and easily be removed by washing and/or pouring water over them.

Crayons or wax pastels are sticks of colored wax, charcoal, chalk or other material used for writing or drawing. A crayon made of pigment with a dry binder is a pastel; when made of oiled chalk, it is called an oil pastel. There are also watercolor crayons, sometimes called water-soluble crayons.

Crayons are available at a range of prices and are easy to work with. They are less messy than most paints and markers, blunt (removing the risk of sharp points present when using a pencil or pen), typically nontoxic, and available in a wide variety of colors. These characteristics make them particularly good instruments for teaching small children to draw in addition to being used widely by student and professional artists.

Traditional crayons are still comprised of paraffin waxes, pigments, and filler material. Despite being designed for writing on paper, many children write with crayons on walls, tables, and other surfaces. Wax crayons are difficult to remove from surfaces and often require scraping or melting, which may damage the underlying surface.

In 1990 Colin Snedeker, a chemist for Binney & Smith (the then-parent company of Crayola), developed the first washable crayons in response to consumer complaints regarding stained fabrics and walls. In the related patent (WO9004621) solid marking compositions comprising a polyethylene glycol resin component, a water-soluble surfactant and a pigment are disclosed.

In a similar patent from 1990, EP0434163, water-soluble crayon compositions comprising one or more water-soluble alkoxylation products and a coloring agent are disclosed, wherein the alkoxylation products can be fatty alcohol ethoxylates.

In U.S. Pat. No. 5,380,357 from 1995 improved water-soluble crayons comprising at least one ethoxylated alcohol, a further water-soluble material selected from the group of ethoxylated sorbitan fatty acid esters, ester derivatives, phenols, ethers and polymeric derivatives and at least a pigment or dye without polyethylene glycols are disclosed. The ethoxylated alcohol is derived from primary linear alcohols (e.g. UNITHOX 480 or 490). The absence of polyethylene glycol reduced the ghosting or residue left on a surface when washed with water. Similar systems of pigment dispersions in ethoxylated alcohols are presented in the publication, US2013/0195784.

US20190048220 tried to overcome the existing drawbacks (e.g. stickiness, little break strength, leaving hands messy) of water-soluble crayons comprising no polyethylene glycols such as the ones from U.S. Pat. No. 5,380,357 and EP0434163 by mixing at least one wax with an ethoxylated fatty alcohol, stearin, a filler and at least one pigment.

All prior art references referred to herein are incorporated by reference for all purposes.

There still is a need for water-soluble coloring compositions, which do not contain a lot of different ingredients such as paraffin waxes or stearin and/or surfactants as well as dispersing agent, which wash away faster and with no mechanical action required and which can also be used as watercolor by applying a wet brush to the surface of the composition. Furthermore, the coloring composition should stay intact at higher temperatures, show a good color development on paper and should not flake or break during use.

### DESCRIPTION OF THE INVENTION

It is surprisingly found that water-soluble coloring compositions comprising
at least one alcohol alkoxylate of the formula (I)

R—O—(C_{z}H_{2z}O)ₓ—H (I)
wherein R is a linear or branched alkyl having a total number of carbon atoms from 20 to 30;
   z has a value of 2 or 3; and
   x has a value from 40 to 160;
at least one filler; and
at least one coloring substance;

show superior stability, washability, and pigment dispersibility.

Preferably, R is a linear or branched alkyl having a total number of carbon atoms from 22 to 30. More preferably, R is a linear or branched alkyl having a total number of carbon atoms from 23 or 24 to 30 and most preferably from 24 to 28. The alkyl moiety “R” may also be a mixture of such alkyl entities having an individual carbon count/molecule consisting essentially of from 20 to 30 and wherein the number average carbon count of the mixture is from 20 to 30 per molecule, preferably from 22 to 30 per molecule, and more preferably from 22 to 28 per molecule.

Preferably, z is 2, so that the alcohol alkoxylate of formula (I) is an alcohol ethoxylate.

Preferably, x has a value of from 45 to 155. More preferably, x has a value of from 100 to 150.

The alcohol ethoxylate may be produced by reaction of a corresponding alcohol with ethylene oxide (EO) over a suitable ethoxylation catalyst. Suitable catalysts are those derived from the Group IA and Group IIA metals including potassium, sodium, calcium, magnesium; typically, the metal is present as a base salt and notably its hydroxide. Certain catalyst species are recognized by their ability to produce narrow range ethoxylated alcohols. Catalysts derived from Group IIA metals, especially calcium or magnesium are typically recognized as being narrow range ethoxylation catalysts. In contrast catalysts derived from Group IA metals, such as potassium hydroxide are generally recognized as giving broad range ethoxylated alcohols.

For the presently disclosed invention; preferably, the alcohol ethoxylate is produced by reaction over a narrow range ethoxylation catalyst, more preferably over a calcium-containing ethoxylation catalyst providing for narrow range ethoxylated alcohols. Such catalysts and use thereof to produce ethoxylated alcohols are known to the person skilled in the art and exemplified by the teachings of, for example, U.S. Pat. No. 4,754,075. Exemplary of a suitable calcium-containing ethoxylation catalyst is the proprietary catalyst system developed by Sasol (USA) Corporation and as disclosed in U.S. Pat. Nos. 4,775,653; 4,835,321; 5,220,077; 5,626,121; 8,329,609 and 9,802,879, the disclosures of which are all incorporated herein by reference.

The alcohol alkoxylate of formula (I) may additionally have, independent of each other, one or more of the following properties:
an average EO-content of from 85 to 95 wt.-%, preferably of from 88 to 95 wt.-%;
a hydrophilic-lipophilic balance (HLB) number of from 17 to 20, preferably of from 17.5 to 19.5;
a hydroxyl number of from 5 to 25, preferably of from 8 to 22;
an average molecular weight of at least 2000 g/mol, preferably of at least 3000 g/mol; and more preferably of at least 5000 g/mol;
a cloud point of from 60 to 75° C., preferably of from 65 to 73° C.;
a melting (range) of from 50 to 65° C., preferably of from 54 to 62° C.;
a time to dissolve in water of from 1200 to 4000 seconds, preferably of from 1300 to 3000 seconds, more preferably at maximum 2500 seconds.

The number and content of ethoxy-units is calculated based on molecular weight obtained by the gas chromatogram of the selected alcohol and the nuclear magnetic resonance spectrum of the ethoxylated alcohols from which the ratio of alcohol- to ethoxy-groups is obtained.

Molecular weight of alcohol=Average molecular weight from gas chromatogram

Average EO-content=Calculated from signal ratio of alcohol-chain to ethoxy groups in NMR-spectrum

Molecular weight of alcohol ethoxylate=Molecular weight of alcohol/(1−Average EO-content)

Number of EO-units (x in the alcohol alkoxylate of formula (I))=(MW of alcohol ethoxylate−MW of alcohol)/44 g/mol

The HLB-value is calculated according to the Griffin's method as follows:

HLB=20*Mₕ/M
Mₕ=molecular weight of the hydrophilic portion of the molecule
M=molecular weight of the whole molecule

The hydroxyl-number is determined according to European standard method DIN EN 13926 and the cloud point is determined according to ASTM D2024. The melting point/range is determined according to standard method ASTM D-127.

The solubility (time to dissolve) is determined by putting a defined amount of alcohol ethoxylate (1 g) in a beaker with 99 ml water at ambient temperature (20° C.) and stirring it with a magnetic stirrer at 300 rpm until the alcohol ethoxylate is completely dissolved.

In further preferred embodiments the water-soluble coloring compositions comprise
10 to 90 wt.-% alcohol ethoxylate, preferably 15 to 50 wt.-% alcohol ethoxylate, more preferably 17.5 to 35 wt.-% alcohol ethoxylate;
90 to 10 wt.-% filler, preferably 85 to 50 wt.-% filler, more preferably 82.5 to 65 wt.-% filler, whereas the filler preferably comprises calcium carbonate, talc, bentonite clay, kaolin clay, or mixtures thereof; and
1 to 5 wt.-% coloring substance in the form of pigment or dye, preferably 1.5 to 2.5 wt.-% pigment or dye, whereas the pigment or dye preferably comprises Violet 19, Green LX-11774, Orange LX 11360, ultramarine pink, titanium dioxide, methylene blue, iron blue, red aluminum lake dye, red calcium lake dye, or mixtures thereof.

In preferred embodiments, the coloring substance is active in the visual wavelength range of 400 nm to 800 nm of the electromagnetic spectrum of light.

In another embodiment of the invention, the water-soluble coloring compositions comprise
15 to 60 wt.-% alcohol ethoxylate, preferably 20 to 40 wt.-% alcohol ethoxylate;
85 to 40 wt.-% filler, preferably 80 to 60 wt.-% filler, whereas the filler preferably comprises calcium carbonate, talc, bentonite clay, kaolin clay, or mixtures thereof; and
1 to 5 wt.-% coloring substance in the form of pigment or dye, preferably 1.5 to 2.5 wt.-% pigment or dye, whereas the pigment or dye preferably comprises Violet 19, Green LX-11774, Orange LX 11360, ultramarine pink, titanium dioxide, methylene blue, iron blue, red aluminum lake dye, red calcium lake dye, or mixtures thereof.

The invention also includes a method of producing water-soluble coloring composition comprising the steps of
providing an alcohol alkoxylate of formula the formula (I)

R—O—(C_{z}H_{2z}O)ₓ—H (I)
wherein R is a linear or branched alkyl having a total number of carbon atoms from 20 to 30;
   z has a value of 2 or 3; and
   x has a value from 40 to 160;
providing a filler;
providing a coloring substance;
melt blending said alcohol alkoxylate, filler and coloring substance under stirring and heating to obtain a melt-blend;
shaping the melt-blend in a selected form; and
cooling down the melt-blend so that it solidifies.

In a preferred embodiment the melt-blend is shaped in the form of a rod or a stick.

Furthermore, the melt-blending is preferably conducted in an injection-molding apparatus and the water-soluble coloring composition is produced by injection molding or in an extruder apparatus and the water-soluble coloring composition is produced by extrusion.

Another alternative is the shaping of the melt-blend comprising
decanting or pouring the melt-blend into a heated mold;
cooling down the melt-blend in the mold with rotating blades so that it solidifies; and
removing, as a casting, the solidified melt-blend from the mold.

The invention also includes the use of an alcohol alkoxylate of the formula (I)

R—O—(C_{z}H_{2z}O)ₓ—H (I)
wherein R is a linear or branched alkyl having a total number of carbon atoms from 20 to 30;
z has a value of 2 or 3; and
x has a value from 40 to 160,

in water-soluble coloring compositions.

This use preferably improves: the mechanical stability of the coloring compositions; the pigment dispersibility, and; the washability as well as the color development of the coloring compositions when applied to different surfaces and/or the ability to remove the coloring compositions with water from any surface to which it has been applied.

### EXAMPLES

The alcohol ethoxylates from Table 1 have been used to prepare water-soluble crayon compositions according to Tables 2 and 3. The MAGNATHOX branded alcohol ethoxylates are new products available from Sasol and have not previously been available for crayon compositions. The alcohol ethoxylates sold under the trademark of UNITHOX are available from Baker-Hughes; and those under the trademark of ALFONIC available from Sasol.

TABLE 1
Properties of alcohol ethoxylates used to prepare crayon compositions.

| | Invention | Invention | Invention | Invention | Comp. | | |
|---|---|---|---|---|---|---|---|
| | MAGNA- | MAGNA- | MAGNA- | MAGNA- | AL- | Comp. | Comp. |
| | THOX | THOX | THOX | THOX | FONIC | Unithox | Unithox |
| Properties | 20 + N-50 | 20 + N-75 | 20 + N-100 | 20 + N-150 | 1214-30 | 480 | 490 |
| Average EO | 88 | 90 | 93 | 95 | 87 | 80 | 90 |
| content (wt %) ¹ | | | | | | | |
| Number of | 45 | 75 | 100 | 150 | 30 | 42 | 95 |
| EO-units ² | | | | | | | |
| Carbon atom | C20+ | C20+ | C20+ | C20+ | C12/14 | C32 | C32 |
| content (“R”) | (av. 21.5) | (av. 21.5) | (av 21.5) | (av. 21.5) | | (av.) | (av.) |
| Molecular weight | 319 | 319 | 319 | 319 | 199 | 460 | 460 |
| of alcohol (g/mol) ³ | | | | | | | |
| HLB ⁴ | 17.6 | 18.2 | 18.6 | 19.0 | 17.4 | 16 | 18 |
| Hydroxyl number | 20-22 | 16-18 | 12-14 | 8-10 | 36 | 22 | 12 |
| DIN EN 13926 | | | | | | | |
| Cloud point (° C.) | 69-73 | 69-70 | 68-69 | 65-67 | 75-75 | n.a. | n.a. |
| ASTM D2204 | | | | | | due to | due to |
| | | | | | | high | high |
| | | | | | | melting | melting |
| Melting point/ | 54-57 | 58-60 | 50-54 | 60-62 | 48.5 | 86 | 71 |
| range (° C.) | | | | | | | |
| ASTM D-127 | | | | | | | |
| Molecular weight | 2658 | 3606 | 4615 | 6380 | 1534 | 2300 | 4600 |
| (g/mol) ⁵ | | | | | | | |
| Time to dissolve | 2068 | 2940 | 1920 | 1306 | 1180 | / | 4473 |
| (sec) ⁶ | | | | | | | |

The number and content of ethoxy-units is calculated based on molecular weight of the used alcohol obtained by the gas chromatogram and the nuclear magnetic resonance spectrum of the alcohol ethoxylates from which the ratio of alcohol- to ethoxy-groups is obtained.
¹ Average EO-content = Calculated from signal ratio of alcohol-chain to ethoxy groups in NMR-spectrum
² Number of EO-units = (MW of alcohol ethoxylate − MW of alcohol)/44 g/mol
³ Molecular weight of alcohol = Average molecular weight from gas chromatogram
⁴ The HLB-value is calculated according to the Griffin's method as follows:
HLB = 20*Mₕ/M
Mₕ = molecular weight of the hydrophilic portion of the molecule
M = molecular weight of the whole molecule
⁵ Molecular weight of alcohol ethoxylate = Molecular weight of alcohol/(1 − Average EO-content)
⁵ The solubility (time to dissolve) is determined by putting a defined amount of alcohol ethoxylate (1 g) in a beaker with 99 ml water at ambient temperature (20° C.) and stirring it with a magnetic stirrer at 300 rpm until the ethoxylated alcohol was completely dissolved.

The number and content of ethoxy-units is calculated based on molecular weight of the used alcohol obtained by the gas chromatogram and the nuclear magnetic resonance spectrum of the alcohol ethoxylates from which the ratio of alcohol- to ethoxy-groups is obtained.

From the values in Table 1 it can be seen that the inventive alcohol ethoxylates are dissolving quicker than the comparative prior art products derived from longer primary alcohols and slower than the one derived from shorter primary alcohols. But the inventive ethoxylates are preferred to the ones derived from shorter primary alcohols as they have a higher melting range, which indicates a higher temperature stability.

TABLE 2
Crayon compositions according to invention.

| Composition [wt.-%] | 1 | 2 | 3 | 4 | 5 | 6 | 7* | 8* | 9* | 10* |
|---|---|---|---|---|---|---|---|---|---|---|
| 20 + N-50 | 35 | | 84 | | | | | | | |
| 20 + N-150 | | 35 | | 84 | | | | | | |
| 20+-100 | | | | | | 35 | | | | |
| 20+-75 | | | | | 35 | | | | | |
| Altonic 1214-30 | | | | | | | 35 | 84 | | |
| UNITHOX 490 | | | | | | | | | 35 | |
| Filler (CaCO₃) | 63 | 63 | 14 | 14 | 63 | 63 | 63 | 14 | 63 | 25.5 |
| Stearic acid | | | | | | | | | | 38.8 |
| Pigment (Violet 19)** | 2 | 2 | 2 | 2 | 2 | 2 | 2 | 2 | 2 | 2.2 |
| Sorbitan Monostearate | | | | | | | | | | 1 |
| Paraffin wax | | | | | | | | | | 4 |
| Polyoxyethylene nonyl | | | | | | | | | | 3 |
| phenol ether | | | | | | | | | | |
| PEG 4000 | | | | | | | | | | 25.5 |

*Comparative examples according to U.S. Pat. No. 5,417,746, U.S. Pat. No. 5,380,357 and EP0434163.
**Violet 19 is a Quinacridone-based pigment.

The crayon compositions 1 to 10 were drawn onto a linoleum tile and water was run at a constant force and pressure from the sink across each section of the tile for 15 seconds. Formulations 1-6 and 9 were completely washed away while formulation 10 was not removed at all and formulations 7 and 8 were only partially removed.

Furthermore, a scrub test was performed to see what influence mechanical force has on removing crayon from the linoleum tiles. A modification of the method according ASTM D-4828 (Practical Washability of Organic Coatings) was used for this. A Gardner Abrasion Tester II Scrubber was used with a scrub rate of 37 strokes per minute. Soiled tiles were scrubbed for 50 strokes with a tap-water soaked sponge. One gram of each crayon formulation was melted and applied to an individual tile and then allowed to solidify. The weight of the tile and formulation was measured before and after the scrub test once the water on the tile had dried.

The results of the scrub tests are set out in Table 3 and clearly show that the inventive crayon compositions can be more easily removed than the prior art crayon compositions.

Advantageously, the inventive compositions can accommodate a larger filler loading which is beneficial in terms of lowering the cost of the crayon composition, while providing superior removal attributes compared to the prior art compositions.

TABLE 3
Results of scrub test of the produced crayon compositions.

| | Tile weight | Tile weight | Composition | |
|---|---|---|---|---|
| | before scrub | after scrub | removed | |
| Composition | [g] | [g] | [g] | Removal % |
| 1 | 84.71 | 84.13 | 0.58 | 56% |
| 2 | 89.55 | 88.72 | 0.83 | 93% |
| 3 | 87.78 | 87.29 | 0.49 | 49% |
| 4 | 85.16 | 84.65 | 0.51 | 60% |
| 5 | 85.21 | 84.49 | 0.72 | 75% |
| 6 | 88.67 | 87.82 | 0.85 | 82% |
| 7* | 85.89 | 85.43 | 0.46 | 54% |
| 8* | 85.23 | 84.57 | 0.66 | 77% |
| 9* | 84.98 | 84.31 | 0.67 | 79% |
| 10* | 89.07 | 89.02 | 0.05 | 5.6% |

The inventive compositions could also be used as a watercolor.

While working with the various samples, it was observed that on a simple snapbreak test the materials of the invention broke and presented relatively few if any sharp edges or flakes. In contrast, the comparative materials in a similar test gave undesirable sharp edges and flakes. While not wishing to be bound by theory, it is believed that the compositions of the invention exhibit a different rate of solidification and crystallization due to being a narrow-range ethoxylated alcohol and of defined EO content, compared to the comparative materials, leading to fewer stress lines in the cooled product. The presence of stress lines is believed to encourage formation of sharp edges and flakes in a snap-break test.

In summary the inventive alcohol ethoxylates clearly overcome the disadvantages of the prior art and provide superior water-soluble coloring compositions.

1. A water-soluble coloring composition comprising
at least one alcohol alkoxylate of the formula (I)
R—O—(C_{z}H_{2z}O)ₓ—H (I)
wherein R is a linear or branched alkyl having a total number of carbon atoms from 20 to 30;
z has a value of 2 or 3; and
x has a value of from 40 to 160;
at least one filler; and
at least one coloring substance.

2. The composition according to claim 1, wherein R is a linear or branched alkyl having a total number of carbon atoms from 22 to 30.

3. The composition according to claim 1, wherein z is 2.

4. The composition according to claim 1, wherein x has a value from 45 to 155.

5. The composition according to claim 3, wherein the alcohol ethoxylate has an average EO-content from 85 to 95 wt.%.

6. The composition according to claim 3, wherein the alcohol ethoxylate has a HLB-number from 17 to 20.

7. The composition according to claim 3, wherein the alcohol ethoxylate has a hydroxyl number from 5 to 25.

8. The composition according to claim 3, wherein the alcohol ethoxylate has at least one of the following characteristics:
an average molecular weight of at least 2000 g/mol,
a cloud point from 60 to 75° C.,
a melting (range) from 50 to 65° C., and
a time to dissolve in water from 1200 to 4000 seconds.

9-11. (canceled)

12. The composition according to claim 3, wherein it comprises 10 to 90 wt.-% alcohol ethoxylate.

13. The composition according to claim 1, wherein it comprises 90 to 10 wt.-% filler.

14. The composition according to claim 1, wherein the coloring substance is active in the visual wavelength range of 400 nm to 800 nm of the electromagnetic spectrum of light.

15. The composition according to claim 14, wherein the coloring substance is a dye or pigment.

16. The composition according to claim 1, wherein the said coloring composition has a rod or stick format.

17. The composition according to claim 1, wherein it is a water-soluble coloring crayon.

18. The composition according to claim 15, wherein it comprises 1 to 5 wt.-% pigment or dye.

19. A method of producing a water-soluble coloring composition comprising the steps of
providing an alcohol alkoxylate of the formula (I)
R—O—(C_{z}H_{2z}O)ₓ—H (I)
wherein R is a linear or branched alkyl having a total number of carbon atoms from 20 to 30;
z has a value of 2 or 3; and
x has a value from 40 to 160;
providing a filler,
providing a coloring substance;
melt blending said alcohol alkoxylate, filler and coloring substance under stirring and heating to obtain a melt-blend;
shaping the melt-blend in a selected form; and
cooling down the melt-blend so that it solidifies.

20. The method according to claim 19, wherein the melt-blend is shaped in the form of a rod or a stick.

21. The method according to claim 19 wherein the melt-blending is conducted in an injection-molding apparatus and the water-soluble coloring composition is produced by injection molding.

22. The method according to claim 19, wherein the melt-blending is conducted in an extruder apparatus and the water-soluble coloring composition is produced by extrusion.

23. The method according to claim 19, wherein the shaping of the melt-blend comprises
decanting or pouring the melt-blend into a heated mold;
cooling down the melt-blend in the mold with rotating blades; and
removing, as a casting, the solidified melt-blend from the mold.

24-25. (canceled)
